(19) United States
(12) Patent Application Publication
(10) Pub. No.: US 2012/0183669 A1
(43) Pub. Date: Jul. 19, 2012

(54) ACIDIC OIL-IN-WATER TYPE EMULSIFIED SEASONING

(75) Inventors: Kaori Oguchi, Tokyo (JP); Masahiro Ariizumi, Tokyo (JP); Satoshi Teraoka, Tokyo (JP); Tomofumi Kimura, Tokyo (JP)

(73) Assignee: KEWPIE CORPORATION, Tokyo (JP)

(21) Appl. No.: 13/391,001

(22) PCT Filed: Aug. 10, 2010
(86) PCT No.: PCT/JP2010/063539

§ 371 Date: Feb. 17, 2012

(30) Foreign Application Priority Data
Aug. 19, 2009 (JP) 2009-190276
Jun. 29, 2010 (JP) 2010-147392

(51) Int. Cl. A23L 1/24

(52) U.S. Cl. 426/605

(57) ABSTRACT

Provided an acidic oil-in-water type emulsified seasoning comprising egg yolk, the content of oils and fats is 10 to 40 mass %, and the oscillating strain and the loss elastic modulus (G″), which are indicative of dynamic viscoelasticity measured by the following condition with a rheometer, have the following relationship.
Condition: At a temperature of 25 to 35° C. and at an angular frequency of 6.2 rad/s
Relationship: A peak of the loss elastic modulus (G″) is present in the range of 1 to 100% of the oscillating strain, and the loss elastic modulus at the peak (G″_{d}) is larger than the maximum value of the loss elastic modulus (G″ₛ) in the range of 0.1 to 1% of the oscillating strain.

### TECHNICAL FIELD

The invention relates to an acidic oil-in-water type emulsified seasoning.

### BACKGROUND ART

Mayonnaise, which is a type of an acidic oil-in-water type emulsified seasoning, generally contains edible oils and fats in high concentration, for example, in a concentration of about 65 mass % or more to 80 mass % or less of the total mass. Mayonnaise is an emulsified seasoning with high viscosity, and its distinctive texture with a sense of volume and good melt-in-the-mouth is appreciated. Also, mayonnaise is an emulsified product containing oils in high concentration, and in mayonnaise, each of oil droplets which are emulsion particles contacts with other adjacent oil droplets, that is, the oil droplets compose tight packing condition (Ford, L. D. et al. in “Food Emulsion: 4th”, Friberg, S. E. et al., p. 533, Marcel Dekker. 2004).

In contrast, in recent years, more and more people have considered health to be an important, for example, more and more people control their calorie, various types of foods the calories of which are lowered compared with conventional products, have been commercially available in order to meet their needs. In the same manner as for mayonnaise, mayonnaise-like foods having lowered calorie content due to a lowered oil content compared to conventional mayonnaise have been commercially available. Unlike mayonnaise, such low-calorie mayonnaise-like foods generally contain 40 mass % or less of edible oils and fats, and therefore oil droplets of the low-calorie mayonnaise-like foods do not compose a tight packing condition (JP-B-7-112414 and JP-A-7-59537). Therefore, it is difficult to obtain products having physicality with high viscosity such as mayonnaise, when oils and fats are merely emulsified with an emulsifier such as egg yolk in manufacturing low-calorie mayonnaise-like foods.

Therefore, JP-B-7-112414 discloses blending starch to an acidic oil-in-water type emulsified food in manufacturing the low-calorie mayonnaise-like food heretofore, in order to obtain a low-calorie mayonnaise-like food having physicality with high viscosity. Also, JP-A-7-59537 discloses a heat-resistant, cryoprotective, and pasty composition with mayonnaise flavor, which contains pregelatinized starch and/or a gum substance.

However, the acidic oil-in-water type emulsified food which contains starch, manufactured by the method described in JP-B-7-112414, provides heavy and gooey texture, and the pasty composition which contains a gum substance, manufactured by the method described in JP-A-7-59537, occasionally provides poor texture such as sticky paste which is peculiar to gum substances. The texture is different from the texture of general mayonnaise having the content of oils and fats in the range of about 65 mass % or more to 80 mass % or less of the total mass.

Accordingly, in general, it is difficult to obtain the same texture as general mayonnaise having a high content of oils and fats with a sense of volume and good melt-in-the-mouth, in manufacturing a low-calorie mayonnaise-like food.

### DISCLOSURE OF THE INVENTION

### Problems to be Solved by the Invention

The invention provides an acidic oil-in-water type emulsified seasoning with a sense of volume and good melt-in-the-mouth in spite of having a low content of oils and fats and being low-calorie.

### Means for Solving the Problems

According to one aspect of the invention, there is provided an acidic oil-in-water type emulsified seasoning comprising egg yolk, the content of oils and fats is 10 to 40 mass %, and the oscillating strain and the loss elastic modulus (G″), which are indicative of dynamic viscoelasticity measured by the following condition with a rheometer, have the following relationship.

Condition: At a temperature of 25 to 35° C. and at an angular frequency of 6.2 rad/s

Relationship: A peak of the loss elastic modulus (G″) is present in the range of 1 to 100% of the oscillating strain, and the loss elastic modulus at the peak (G″_{d}) is larger than the maximum value of the loss elastic modulus (G″ₛ) in the range of 0.1 to 1% of the oscillating strain.

In the above-mentioned acidic oil-in-water type emulsified seasoning, G″_{d} and G″ₛ may have the following relationship.

G″_{d}/G″ₛ≧1.5

In the above-mentioned acidic oil-in-water type emulsified seasoning, the peak of the loss elastic modulus (G″) may be present in the range of 10 to 40% of the oscillating strain.

The above-mentioned acidic oil-in-water type emulsified seasoning may further comprise a cross-linked starch, the cross-linked starch may have the following characteristics:

the viscosity of a mixture of the cross-linked starch and water prepared under the following condition is 120 to 20,000 mPa·s; and

the average particle diameter of the cross-linked starch being present in the mixture is 20 to 40 micrometers.

Condition: A mixture of the cross-linked starch and water comprising 8 mass % of the cross-linked starch is heated up to 90° C., and then is maintained at 90° C. for 5 minutes, and then is cooled to 20° C., and then is stirred at 10,000 rpm for 5 minutes with a homomixer.

In the above-mentioned acidic oil-in-water type emulsified seasoning, the cross-linked starch may have a shear resistance of 0.7 to 0.9 calculated from the following procedures (1) to (3).

procedure (1): A mixture of the cross-linked starch and water comprising 8 mass % of the cross-linked starch is heated up to 90° C., and then is maintained at 90° C. for 5 minutes, and then is cooled to 20° C., and then is stirred with a vertical mixer (to which a wire whip is attached) on scale 6 for 3 minutes to obtain a resulting mixture, and a volume average particle diameter A of the cross-linked starch in the resulting mixture is measured by laser diffraction particle size distribution analysis.

procedure (2): The mixture of the cross-linked starch and water comprising 8 mass % of the cross-linked starch obtained by procedure (1) is stirred at 10,000 rpm for 5 minutes with a homomixer to obtain a resulting mixture, and a volume average particle diameter B of the cross-linked starch in the resulting mixture is measured by laser diffraction particle size distribution analysis.

procedure (3): A shear resistance is calculated from the following calculating formula.

shear resistance=B/A

In this instance, in the above-mentioned acidic oil-in-water type emulsified seasoning, the content of the cross-linked starch in an aqueous phase portion of the acidic oil-in-water type emulsified seasoning may be 2 to 10 mass %. As used herein, the content of the cross-linked starch in the aqueous phase portion of the acidic oil-in-water type emulsified seasoning refers to a value (%) obtained by dividing the mass of the cross-linked starch by the mass of the aqueous phase portion, and the mass of the aqueous phase portion refers to a value obtained by subtracting the mass of oil phase from the mass of the acidic oil-in-water type emulsified seasoning.

The above-mentioned acidic oil-in-water type emulsified seasoning may further comprises a hotwater-soluble polysaccharide thickener (except a starch) in an aqueous phase, and the average particle diameter of the hotwater-soluble polysaccharide thickener being present in the aqueous phase may be 15 to 200 micrometers.

The above-mentioned acidic oil-in-water type emulsified seasoning may further comprises water-containing solid particles and oil droplets, the average particle diameter of the water-containing solid particles may be larger than the average particle diameter of the oil droplets, in the case the average particle diameter of the oil droplet is defined as average particle diameter 1 and the average particle diameter of the water-containing solid particles is defined as average particle diameter 2, the ratio of the average particle diameter 2 to the average particle diameter 1 (the average particle diameter 2/the average particle diameter 1) may be 5 to 50. In this instance, the proportion of the water-containing solid particles per unit volume of an aqueous phase may be 5 to 50%.

### Effect of the Invention

Since the above-mentioned acidic oil-in-water type emulsified seasoning has the content of oils and fats of 10 to 40 mass %, comprising egg yolk, and the oscillating strain and the loss elastic modulus (G″), which are indicative of dynamic viscoelasticity measured by the following condition with a rheometer, have the following relationship, the above-mentioned acidic oil-in-water type emulsified seasoning has a sense of volume and good melt-in-the-mouth, in spite of having a low content of oils and fats and being low-calorie.

### BRIEF DESCRIPTION OF THE DRAWINGS

FIG. 1 is a graph representing dynamic viscoelasticity (a relationship between oscillating strain and loss elastic modulus (G″)) of each semi-solid salad dressing manufactured in Examples 1 to 3 and Comparative Examples 1 to 2, respectively, measured with a rheometer.

FIG. 2 is a graph representing particle size distributions of the semi-solid salad dressings manufactured in Example 1 and Comparative Example 1, respectively.

FIG. 3 is an optical photomicrograph of the semi-solid salad dressing manufactured in Example 1.

FIG. 4 is an optical photomicrograph of the semi-solid salad dressing manufactured in Comparative Example 1.

FIG. 5 is a graph representing dynamic viscoelasticity (a relationship between oscillating strain and loss elastic modulus (G″)) of each semi-solid salad dressing manufactured in Examples 4 to 6, respectively, measured with a rheometer.

FIG. 6 is an optical photomicrograph of the semi-solid salad dressing manufactured in Example 4.

### BEST MODE FOR CARRYING OUT THE INVENTION

An acidic oil-in-water type emulsified seasoning according to one embodiment of the invention is described in detail below.

### 1. Acidic Oil-in-Water Type Emulsified Seasoning

An acidic oil-in-water type emulsified seasoning according to one embodiment of the invention has the content of oils and fats of 10 to 40 mass %, comprising egg yolk, and the oscillating strain and the loss elastic modulus (G″), which are indicative of dynamic viscoelasticity measured by the following condition with a rheometer, have the following relationship.

Condition: At a temperature of 25 to 35° C. and at an angular frequency of 6.2 rad/s

Relationship: A peak of the loss elastic modulus (G″) is present in the range of 1 to 100% of the oscillating strain, and the loss elastic modulus at the peak (G″_{d}) is larger than the maximum value of the loss elastic modulus (G″ₛ) in the range of 0.1 to 1% of the oscillating strain.

The acidic oil-in-water type emulsified seasoning according to this embodiment is an acid seasoning (having pH of 4.6 or less) in which edible oils and fats are dispersed as oil droplets nearly homogeneously in aqueous phase to maintain an oil-in-water type emulsion state, and examples of the acidic oil-in-water type emulsified seasoning according to this embodiment include low-calorie mayonnaise-like foods, low-calorie semi-solid salad dressings, or the like, which have a lower content of the oils and fats compared with general mayonnaise. Furthermore, semi-solid salad dressings used herein refers to salad dressings having the viscosity of 30,000 mPa·s or more.

1.1. Loss Elastic Modulus (G″)

1.1.1. Principle

According to the invention, the dynamic viscoelasticity of the acidic oil-in-water type emulsified seasoning is measured by using a rheometer. Dynamic viscoelasticity used in the invention refers to a viscoelastic behavior observed when stress or strain is applied sinusoidally to a viscoelastic body (the acidic oil-in-water type emulsified seasoning of the invention). More specifically, viscoelastic functions such as a storage elastic modulus (G′) and a loss elastic modulus (G″) can be defined based on a behavior of a variation of stress for a variation of oscillating strain of a viscoelastic body, measured by using a rheometer, and the viscoelastic functions are indicators of dynamic viscoelasticity.

The inventors of this application measured the dynamic viscoelasticity of the acidic oil-in-water type emulsified seasoning according to one embodiment of the invention by using a rheometer under the above-mentioned condition and have found that the acidic oil-in-water type emulsified seasoning according to one embodiment of the invention has such a particular dynamic viscoelasticity that existing low-calorie mayonnaise-like foods having the content of 40 mass % or less do not have.

More specifically, a variation of the loss elastic modulus (G″) for a variation of the oscillating strain of the acidic oil-in-water type emulsified seasoning according to this embodiment (for example, a mayonnaise-like food) fulfills the above-mentioned relationship, the acidic oil-in-water type emulsified seasoning according to this embodiment demonstrates the similar dynamic viscoelasticity as general mayonnaise having the high content of oils and fats and containing oil droplets which are emulsion particles in a tight packing condition (for example, mayonnaise having the content of oils and fats in the range of about 65 mass % or more to 80 mass % or less of the total mass).

The dynamic viscoelasticity measured by using a rheometer under the above-mentioned condition in the invention is designed under the assumption of oral behavior when the acidic oil-in-water type emulsified seasoning (in particular, mayonnaise or a mayonnaise-like food) is eaten. That is, the variation of the loss elastic modulus (G″) is measured when the oscillating strain of the viscoelastic body gradually increases by applying strain sinusoidally to the viscoelastic body at a constant frequency in the measurement of the oscillating strain of the viscoelastic body by using a rheometer according to the invention.

In the case that the acidic oil-in-water type emulsified seasoning according to this embodiment is eaten, constitutional deformation of the seasoning is small in a stage when the acidic oil-in-water type emulsified seasoning according to this embodiment just gets into the rictus (stage 1), and mastication is performed within the rictus in the aim of mixing the acidic oil-in-water type emulsified seasoning according to this embodiment and saliva to provide a fluidity to the acidic oil-in-water type emulsified seasoning according to this embodiment and to move the acidic oil-in-water type emulsified seasoning according to this embodiment from the rictus to the esophagus eventually, and generally, the movement of the rictus is harder with the progress of the mastication (stage 2). In the invention, the behavior of the acidic oil-in-water type emulsified seasoning according to this embodiment in the rictus (the above-mentioned stages 1 and 2) is mimicked by increasing the deformation of the acidic oil-in-water type emulsified seasoning (by increasing the oscillating strain) with a rheometer.

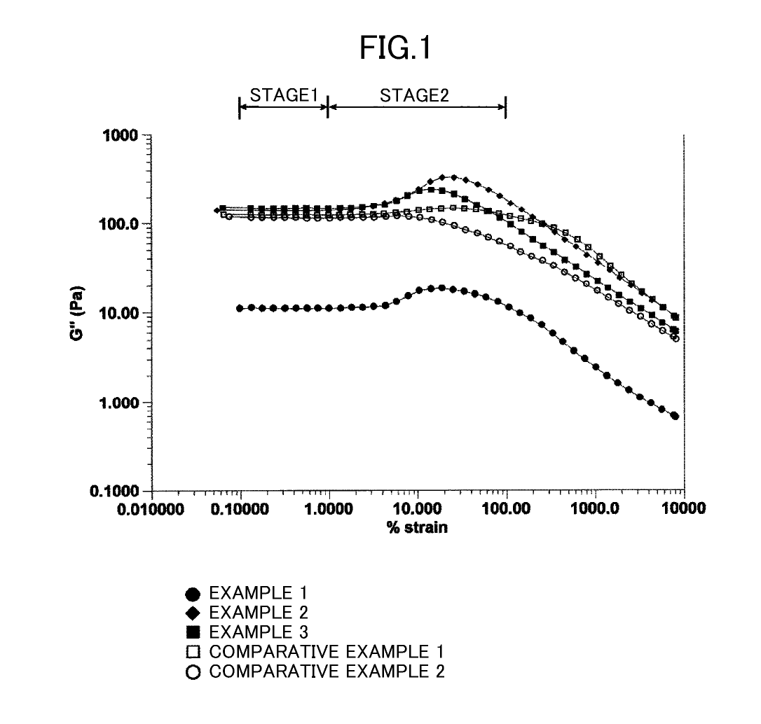

Examples representing the series of the rictus movements when the acidic oil-in-water type emulsified seasoning according to this embodiment is eaten, are the dynamic viscoelasticity (FIG. 1 and FIG. 5) of semi-solid salad dressings (acidic oil-in-water type emulsified seasonings) of Examples 1 to 6 to be hereinafter described. In FIG. 1 and FIG. 5, the horizontal axis represents oscillating strain, and the vertical axis represents loss elastic modulus (G″)

The state in which the deformation of the acidic oil-in-water type emulsified seasoning according to this embodiment is small since the acidic oil-in-water type emulsified seasoning is just put into the rictus in stage 1, corresponds the state of “0.1 to 1% of the oscillating strain”. For example, with reference to Examples 1 to 3 in FIG. 1 and Examples 4 to 6 in FIG. 5, the variation of the loss elastic modulus is small in the range of 0.1 to 1% of the oscillating strain.

Also, the state in which the rictus movement is activated in stage 2 corresponds to the state of “1 to 100% of the oscillating strain” in the above-mentioned relationship. For example, with reference to Examples 1 to 3 in FIG. 1 and Examples 4 to 6 in FIG. 5, a peak of the loss elastic modulus (G″) is present in the range of 1 to 100% of the oscillating strain, and the loss elastic modulus at the peak (G″_{d}) is larger than the maximum value of the loss elastic modulus (G″ₛ) in the range of 0.1 to 1% of the oscillating strain. It is speculated that the range of 1 to 100% of the oscillating strain corresponds to the stage in which the rictus movement becomes active, and the peak of the loss elastic modulus (G″) responds to the stage in which a sense of volume (robust texture, a sense of existence) becomes maximum in the rictus due to the constitutional deformation of the acidic oil-in-water type emulsified seasoning according to this embodiment.

Further, as the above-mentioned peak is passed and the oscillating strain further increases, the loss elastic modulus decreases. This means the constitution of the acidic oil-in-water type emulsified seasoning according to this embodiment is destroyed, a sense of volume becomes small, and a sense of good melt-in-the-mouth may be obtained when the rictus movement continues after a sense of volume of the acidic oil-in-water type emulsified seasoning according to this embodiment become maximum in the rictus (after the above-mentioned peak is passed).

Furthermore, as described above, general mayonnaise with a sense of volume and good melt-in-the-mouth, which has the content of the oils and fats in the range of about 65 mass % or more to 80 mass % or less of the total mass, has the similar dynamic viscoelasticity to the dynamic viscoelasticity of the acidic oil-in-water type emulsified seasoning according to this embodiment described above. Accordingly, it is understandable that the acidic oil-in-water type emulsified seasoning according to this embodiment has a sense of volume and good melt-in-the-mouth, like general mayonnaise having the high content of oils and fats.

Also, in the acidic oil-in-water type emulsified seasoning according to this embodiment, in terms of a sense of higher volume and better melt-in-the-mouth, the loss elastic modulus (G″_{d}) and the maximum value of the loss elastic modulus in the range of 0.1 to 1% of the oscillating strain (G″ₛ) have preferably the following relationship, G″_{d}/G″ₛ≧1.5, more preferably G″_{d}/G″ₛ≧1.6, in general, G″ₛ is 1.5 to 4 (preferably, 1.5 to 3).

Further, in the acidic oil-in-water type emulsified seasoning according to this embodiment, the peak of the loss elastic modulus (G″) is preferably present in the range of 10 to 40% of the oscillating strain, more preferably in the range of 10 to 30% of the oscillating strain. Since the peak of the oscillating strain (G″) is present in the above-mentioned range of the oscillating strain in the acidic oil-in-water type emulsified seasoning according to this embodiment, a sense of higher volume and better melt-in-the-mouth can be obtained.

On the other hand, the dynamic viscoelasticity (FIG. 1) of the semi-solid salad dressing of Comparative Example 1 (acidic oil-in-water type emulsified seasoning) described later is an example representing specifically the above-mentioned series of the rictus movement when an existing acidic oil-in-water type emulsified seasoning having the content of oils and fats of 40 mass % or less is eaten. That is, the semi-solid salad dressing of Comparative Example 1 is an example of an existing semi-solid salad dressing having the content of oils and fats of 40 mass % or less.

As described above, stage 1 represents a stage in which the acidic oil-in-water type emulsified seasoning has just put into the rictus and the rictus movement is slow, and in this stage, the behavior of the dynamic viscoelasticity does not differ substantially from the dynamic viscoelasticity of the semi-solid salad dressings (acidic oil-in-water type emulsified seasonings) of the above-mentioned Examples 1 to 6.

Also, stage 2 corresponds to stage 2 of the dynamic viscoelasticity of the above-mentioned semi-solid salad dressings (acidic oil-in-water type emulsified seasonings) of Examples 1 to 6. With reference to FIG. 1, a peak of the loss elastic modulus (G″) is absent in the range of 1 to 100% of oscillating strain in the dynamic viscoelasticity of the semi-solid salad dressing of Comparative Example 1. Accordingly, it is understandable that a sense of volume of the acidic oil-in-water type emulsified seasoning of Comparative Example 1 does not increase in the rictus when the acidic oil-in-water type emulsified seasoning of Comparative Example 1 is eaten and the rictus movement becomes active in the range of 1 to 100% of the oscillating strain (the loss elastic modulus increases). Furthermore, “a peak of the loss elastic modulus (G″) is absent in the range of 1 to 100% of oscillating strain” used in the invention refers to G″_{d} and G″ₛ have the following relationship, “G″_{d}/G″ₛ≦1.2”.

That is, it is understandable from the result shown in FIG. 1 that an existing acidic oil-in-water type emulsified seasoning having the content of oils and fats of 40 mass % or less (Comparative Example 1) has texture without a sense of volume and good melt-in-the-mouth.

1.1.2. Measuring Apparatus

An apparatus measuring dynamic viscoelasticity of a sample as a measuring object in the invention is a rheometer. For example, high-accuracy rheometers such as the ones commercially available under the trade name “ARES-RFS”, “AR-2000”, and “AR-G2” (manufactured by TA Instruments), “RS600” (manufactured by Thermo Haake Inc.), and “MCR-501” and “MCR-301” (manufactured by Anton Paar GmbH) may be used as a rheometer. More specifically, dynamic viscoelasticity of a sample is preferably measured by using a rheometer under the above-mentioned condition with a phi 40 mm parallel plate and a clearance of 500 to 2,000 micrometers.

1.2. Cross-Linked Starch

The acidic oil-in-water type emulsified seasoning according to this embodiment may further comprise cross-linked starch. In the acidic oil-in-water type emulsified seasoning according to this embodiment, at least apart of the cross-linked starch is preferably present without dissolving, more specifically, the cross-linked starch may be present as particles in a swelling (water-absorbing) state.

The cross-linked starch used in the acidic oil-in-water type emulsified seasoning according to this embodiment is obtained by cross-linking some of hydroxyl groups in a starch molecule, and cross-linking methods are acetylated adipate cross-linking, acetylated phosphate cross-linking, or the like. Starch, which is a raw material of the cross-linked starch, is not particularly limited based on its type, but may be for example, potato starch, cornstarch (for example, cornstarch originating from sweet corn, cornstarch originating from dent corn, cornstarch originating from waxy corn), tapioca starch, sago starch, ocarina starch, wheat starch, or rice starch, in particular, cornstarch or tapioca starch is preferable because these particle diameters are generally arranged in the range of about 20 to 40 micrometers, and therefore the cross-linked starch having the average particle diameter described later can be easily adjusted.

The average particle diameter of the cross-linked starch is 20 to 40 micrometers, preferably 25 to 35 micrometers. The average particle diameter of the cross-linked starch as used herein refers to a value (volume average particle diameter) obtained by measuring an average particle diameter of a mixture, based on laser diffraction particle size distribution analysis, and the mixture is obtained by the following steps: 500 g of a mixture of cross-linked starch and water which contains 8 mass % of the cross-linked starch is heated up to 90° C., and then is maintained at 90° C. for 5 minutes, and then is cooled to 20° C., and then is stirred at 10,000 rpm for minutes using a homomixer (TK homomixer MARKII2.5type, manufactured by PRIMIX Corporation).

Also, the cross-linked starch has preferably the following characteristic: the viscosity of the mixture obtained by heating a mixture of cross-linked starch and water which contains 8 mass % of the cross-linked starch to 90° C., then maintaining at 90° C. for 5 minutes, then cooling to 20° C., and then stirring at 10,000 rpm for 5 minutes using a homomixer, is preferably 120 to 20,000 mPa·s, and more preferably 150 to 15,000 mPa·s. Furthermore, the viscosity of the mixture of cross-linked starch and water which contains 8 mass % of the cross-linked starch after the stirring process at 10,000 rpm for 5 minutes using a homomixer, used in the invention, refers to a value specified by types of raw material starch, cross-linking methods, and degrees of cross-linking. For example, as the viscosity of the mixture of cross-linked starch and water which contains 8 mass % of the cross-linked starch after the above-mentioned stirring process for 5 minutes is lower, the degree of cross-linking is higher and swelling of the cross-linked starch is further prevented.

Since the acidic oil-in-water type emulsified seasoning having a low content of oils and fats contains the cross-linked starch having the above-mentioned range of the average particle diameter and the above-mentioned range of the viscosity and the cross-linked starch contacts with the oil droplets to form a tight packing condition, the peak of the loss elastic modulus (G″) can be present at a stage (stage 2) in the range of 1 to 100% of the oscillating strain, which represents the rictus movement becomes active, and the loss elastic modulus at the peak (G″_{d}) can be larger than the maximum value of the loss elastic modulus (G″ₛ) in the range of 0.1 to 1% of the oscillating strain. Furthermore, the viscosity and the average particle diameter of the mixture of cross-linked starch and water which contains 8 mass % of the cross-linked starch, after the mixture of cross-linked starch and water which contains 8 mass % of the cross-linked starch is heated to 90° C., and then is maintained at 90° C. for 5 minutes, and then is cooled to 20° C., and then is stirred at 10,000 rpm for 5 minutes using a homomixer, used in the invention, refer to values specified by types of raw material starch, cross-linking methods, and degrees of cross-linking. As is clear from the fact that the average particle diameter of the heated mixture of cross-linked starch and water is measured, the cross-linked starch according to the invention maintains the particle state in foods since the cross-linking prevents breakup of the starch particles. As described, in the case that a certain amount of cross-linking is applied, the above-mentioned average particle diameter measured in the invention mainly depends on the size of the starch which is a raw material. Also, the above-mentioned viscosity measured in the invention mainly depends on degree of cross-linking, as the degree of cross-linking is higher, the swelling of the starch is further prevented and the viscosity is further reduced. The cross-linked starch having the above-mentioned range of the average particle diameter and the above-mentioned range of the viscosity is moderately cross-linked, and the swelling of the starch is moderately prevented, and the cross-linked starch has the similar property to oil droplets which are emulsion particles.

Furthermore, “mixture of cross-linked starch and water” used in the invention incorporates not only an aqueous solution in which cross-linked starch is dissolved but also a water dispersion in which cross-linked starch is dispersed, and therefore, the mixture of cross-linked starch and water may be either the aqueous solution or the water dispersion.

The viscosity of the mixture of cross-linked starch and water is a value obtained from readings at the time the after-mentioned rotor turns around two cycles after the measurement starts, by using a BH viscometer under the condition that the initial temperature is 20° C. and the rotation frequency is 20 rpm, and rotor No. 1 is used when the viscosity is less than 375 mPa·s, rotor No. 2 is used when the viscosity is in the range of 375 mPa·s or more to less than 1,500 mPa·s, rotor No. 3 is used when the viscosity is in the range of 1,500 mPa·s or more to less than 3,750 mPa·s, rotor No. 4 is used when the viscosity is in the range of 3,750 mPa·s or more to less than 7,500 mPa·s, rotor No. 5 is used when the viscosity is in the range of 7,500 mPa·s or more to less than 15,000 mPa·s, and rotor No. 6 is used when the viscosity is 15,000 mPa·s or more.

In general, when the viscosity of starch is measured, a mixture of starch and water which contains 8 mass % of the starch is measured. Also, starch having a high degree of cross-linking occasionally precipitates in water, having difficulty in dispersing homogeneously, and therefore the stirring process under the above-mentioned condition is performed in the aim of measurement without variation. Furthermore, a homomixer is a stirring apparatus generally used for manufacturing foods, cosmetics, and the like for a long time, the rotation frequency of the homomixer may be adjusted.

Further, the cross-linked starch used in the acidic oil-in-water type emulsified seasoning according to this embodiment has preferably a shear resistance of 0.7 to 0.9, more preferably 0.8 to 0.9, calculated as follows. In this case, when the shear resistance is less than 0.7, the cross-linked starch has properties such that breakup and gelatinization easily occur and the surfaces of the cross-linked starch particles are easily hydrated, and thus it is difficult to obtain the acidic oil-in-water type emulsified seasoning with a sense of volume and good melt-in-the-mouth. In contrast, when the shear resistance is more than 0.9, the cross-linked starch has properties such that breakup and gelatinization hardly occur and the surfaces of the cross-linked starch particles are hardly hydrated, and thus it is difficult for the cross-linked starch to have properties similar to oil droplets which are emulsion particles, and therefore it is difficult to obtain the acidic oil-in-water type emulsified seasoning with a sense of volume and good melt-in-the-mouth. That is, in the invention, “shear resistance” of the cross-linked starch is an index representing the difficulty of breakup and gelatinization and the difficulty of hydration of the surface of the cross-linked starch. In fact, when the shear resistance is high, breakup and gelatinization hardly occur, and as a result, the surface of the cross-linked starch is hardly hydrated. In contrast, when the shear resistance is low, breakup and gelatinization easily occur, and as a result, the surface of the cross-linked starch is easily hydrated.

The shear resistance can be evaluated by examining a change of the particle size before and after applying shear to the mixture of cross-linked starch and water which contains 8 mass % of the cross-linked starch, specifically, the shear resistance can be evaluated in accordance with the following procedures. Furthermore, “applying shear” used in the invention refers to applying a mechanical shear process.

procedures: At first, the particle diameter of the cross-linked starch before applying shear is measured. In fact, 500 g of a mixture of the cross-linked starch and water comprising 8 mass % of the cross-linked starch is heated up to 90° C., and then is maintained at 90° C. for 5 minutes, and then is cooled to 20° C., and then is stirred with a vertical mixer (Kitchenaid, stand mixer, type name KSM5, which a wire whip is attached to) on scale 6 for 3 minutes to obtain a resulting mixture, and a value (volume average particle diameter) A is measured for the cross-linked starch in the resulting mixture by laser diffraction particle size distribution analysis. Next, the particle diameter of the cross-linked starch in the obtained mixture of the cross-linked starch and water after applying the shear is measured. In fact, the obtained mixture of the cross-linked starch and water, which comprises 8 mass % of the cross-linked starch, is stirred at 10,000 rpm for 5 minutes using TK homomixer MARKII2.5type (manufactured by PRIMIX Corporation) to obtain a resulting mixture, and a value (volume average particle diameter) B is measured for the cross-linked starch in the resulting mixture by laser diffraction particle size distribution analysis. Subsequently, shear resistance is obtained by the following calculating formula.

shear resistance=B/A

In the case the shear resistance is within the above-mentioned range, the acidic oil-in-water type emulsified seasoning has a sense of volume and goodmelt-in-the-mouth, in spite of having a low content of oils and fats (the content of oils and fats of 10 to 40 volume %), may be obtained. Furthermore, the shear resistance used in the invention refers to a value specified by types of raw material starch, cross-linking methods, and further degrees of cross-linking. For example, as the shear resistance is higher, the cross-linking to prevent swelling of the starch particles is stronger.

The cross-linked starch which meets the above-mentioned conditions is for example, trade name “Farinex VA70WM” (manufactured by Matsutani Chemical Industry, Co., Ltd.), trade name “Foodstarch HR-7” (manufactured by Matsutani Chemical Industry, Co., Ltd.), or the like.

Also, since the acidic oil-in-water type emulsified seasoning according to this embodiment may have a sense of volume, the content of the cross-linked starch in an aqueous phase portion of the acidic oil-in-water type emulsified seasoning according to this embodiment is preferably 2 to 10 mass % of the aqueous phase portion. When the content ratio (mass ratio) of the cross-linked starch in the aqueous phase portion is less than 2 mass %, it is difficult to have a cross packing condition between the cross-linked starch and oil droplets in the acidic oil-in-water type emulsified seasoning, and the cross-linked starch hardly contributes to provide a moderate viscosity to the acidic oil-in-water type emulsified seasoning. Also, a peak of loss elastic modulus (G″) is hardly formed in the range of 1 to 100% of oscillating strain. In contrast, when the content ratio (mass ratio) of the cross-linked starch in the aqueous phase portion is more than 10 mass %, the cross packing condition between the cross-linked starch and oil droplets in the acidic oil-in-water type emulsified seasoning is so dense that it is difficult to form the above-mentioned peak.

Furthermore, the content of the above-mentioned cross-linked starch used in the invention is a value converted as an anhydrous substance. In fact, not only the above-mentioned mixture of the cross-linked starch and water containing 8 mass % of the cross-linked starch, but also the content of the cross-linked starch in the aqueous phase portion of the acidic oil-in-water type emulsified seasoning, described above, are values converted as anhydrous substances.

1.3. Hotwater-Soluble Polysaccharide Thickener Except Starch

The acidic oil-in-water type emulsified seasoning according to this embodiment may comprise a hotwater-soluble polysaccharide thickener (except a starch) in the aqueous phase, and the average particle diameter of the hotwater-soluble polysaccharide thickener being present in the aqueous phase is 15 to 200 micrometers. That is, the acidic oil-in-water type emulsified seasoning according to this embodiment contains the hotwater-soluble polysaccharide thickener (except a starch) in the aqueous phase, which is in a condition such that the average particle diameter of the hotwater-soluble polysaccharide thickener (except starch) is 15 to 200 micrometers in the aqueous phase.

Examples of the hotwater-soluble polysaccharide thickener (except a starch) used in the invention include, for example, gellan gum, carrageenan, locust bean gum, tara gum, gum arabic, tamarind gum, sodium alginate, pectine, konjacmannan, or the like and being hotwater-soluble, and one or more of these may be used either individually or in combination. Particularly, gellan gum, carrageenan, locust bean gum, tara gum, gum arabic, tamarind gum, or the like and being hotwater-soluble (hotwater-soluble gum substances) are preferably used. “hotwater-soluble (gum substance)” used herein refers to (a gum substance having) a property the dissolution temperature of which exceeds 55° C., more specifically, the hotwater-soluble gum substance is such that the viscosity of the water dispersion liquid obtained by heating a water dispersion liquid containing 1% of a gum substance at 55° C. and then cooling the water dispersion liquid to 20° C., is less than 80% of the viscosity of the water dispersion liquid obtained by heating the water dispersion liquid containing 1% of the gum substance at 90° C. and then cooling the water dispersion liquid to 20° C.

Since the acidic oil-in-water type emulsified seasoning according to this embodiment may obtain a moderate sense of volume, the content of the hotwater-soluble polysaccharide thickener (except a starch) being in a condition such that the average particle diameter is 15 to 200 micrometers, is preferably 0.1 to 5% of the aqueous phase portion, and more preferably 0.1 to 3%.

The average particle diameter of the hotwater-soluble polysaccharide thickener can be measured in an optical photomicrograph of the acidic oil-in-water type emulsified seasoning according to this embodiment. That is, the hotwater-soluble polysaccharide thickener can maintain a particle state in foods. The average particle diameter of the hotwater-soluble polysaccharide thickener used in the acidic oil-in-water type emulsified seasoning may be 15 to 200 micrometers (preferably 50 to 150 micrometers). The average particle diameter of commercially-available powdery hotwater-soluble polysaccharide thickener (particularly, a hotwater-soluble gum substance) ordinarily depends on a manufacturing process of the hotwater-soluble polysaccharide thickener. In fact, the average particle diameter of commercially-available powdery hotwater-soluble polysaccharide thickener depends on a crushing process of a raw material hotwater-soluble polysaccharide thickener, and mesh size of filtrate used in a filtration process, or the like. In this case, the size of the hotwater-soluble polysaccharide thickener in the acidic oil-in-water type emulsified seasoning according to this embodiment, which differs among types, is ordinarily not exactly the same as the size in a drying condition, and the hotwater-soluble polysaccharide thickener is swelling due to absorption of water. The hotwater-soluble polysaccharide thickener such that the average particle diameter in the acidic oil-in-water type emulsified seasoning according to this embodiment is in the above-mentioned range, is dispersed in a moderately swollen state in the aqueous phase, having the similar property to the oil droplets which are emulsion particles.

Furthermore, the average particle diameter of the hotwater-soluble polysaccharide thickener used in the invention refers to a value obtained by observing an acidic oil-in-water type emulsified seasoning with a an optical microscope, measuring the particle diameters of the 100 particles of the hotwater-soluble polysaccharide thickener in the acidic oil-in-water type emulsified seasoning (in this instance, an average value of longer diameter and shorter diameter is measured as a particle diameter.), and calculating the average value of the particle diameters.

In the case the acidic oil-in-water type emulsified seasoning contains the hotwater-soluble polysaccharide thickener, preferably, the acidic oil-in-water type emulsified seasoning further contains a thickner, and in this instance, the thickner preferably dissolves in the aqueous phase since the hotwater-soluble polysaccharide thickener is homogenously dispersed in the aqueous phase to maintain the contact of the water-containing solid particles with the oil droplets which are emulsion particles easily and therefore a sense of volume and good melt-in-the-mouth can be provided when the viscosity of the aqueous phase which contains the hotwater-soluble polysaccharide thickener in a particle state is adjusted at 100 to 400,000 mPa·s, preferably 200 to 300,000 mPa·s. Examples of the thickener include, for example, starch such as potato starch, cornstarch, tapioca starch, wheat starch, rice starch, modified starch obtained by processing (such as gelatinateing, cross-linking) these starch, and starch treated with heat and humidity; gum substances such as xanthane gum, tamarind gum, locust bean gum, gellan gum, guar gum, gum arabic, psyllium seed gum; pectine; and gelatine.

The content of the thickener is preferably 0.01 to 10%, more preferably 0.1 to 8% of the aqueous phase since the hotwater-soluble polysaccharide thickener is homogenously dispersed in the aqueous phase to maintain the contact of the water-containing solid particles with the oil droplets which are emulsion particles easily and therefore a sense of volume and good melt-in-the-mouth can be provided when the viscosity of the aqueous phase is adjusted at 100 to 400,000 mPa·s, preferably 200 to 300,000 mPa·s in the acidic oil-in-water type emulsified seasoning according to this embodiment.

1.4. Other Components

As described above, the acidic oil-in-water type emulsified seasoning according to this embodiment further comprises oils and fats (edible oils and fats) and egg yolk. In order to manufacture the acidic oil-in-water type emulsified seasoning according to this embodiment being low-calorie, the oils and fats content is preferably 10 to 40 mass %, more preferably 10 to 35 mass %. Also, the content of the egg yolk in the acidic oil-in-water type emulsified seasoning according to this embodiment is preferably 5 to 50 mass % (more preferably 10 to 40 mass %) on raw egg yolk basis.

As described later, the acidic oil-in-water type emulsified seasoning according to this embodiment may be manufactured by emulsifying aqueous phase and oil phase with an emulsifier.

An aqueous phase component of the acidic oil-in-water type emulsified seasoning according to this embodiment is not particularly limited, but including in addition to water, for example, egg yolk, vinegars (fermented vinegars), salts (sodium chloride), seasonings, carbohydrates, spices, coloring and flavorings, and one or more of these may be used either individually or in combination.

Examples of the egg yolk are not particularly limited unless being used generally for edible use, but include, for example, in addition to raw egg yolk, egg yolk obtained by treating raw egg yolk with one or more process including sterilization process, refrigeration process, drying process such as spray drying or freeze drying, enzymatic process with phospholipase A1, phospholipase A2, phospholipase C, phospholipase D, protease, or the like, desugaring process with yeast, glucoseoxidase, or the like, decholesterolling process such as supercritical carbon dioxide process or the like, mixing process with salt or carbohydrates, and one or more of these may be used either individually or in combination.

An oil phase component of the acidic oil-in-water type emulsified seasoning according to this embodiment is mainly oils and fats (edible oils and fats), and examples of the oils and fats include, for example, edible vegetable oil (for example, rapeseed oil, soybean oil, safflower oil, sunflower oil, corn oil, olive oil, grape seed oil, sesame oil, cotton seed oil, perilla seed oil, linseed oil), fish oil, liver oil, further, ester-exchanged oils and fats, and oils and fats containing mainly diglycerides, and one or more of these may be used either individually or in combination.

Also, an emulsifier which may be used in the acidic oil-in-water type emulsified seasoning according to this embodiment is appropriately selected based on the use, including for example, in addition to egg yolk described above, egg yolk lecithin, milk proteins, soybean proteins, monoglycerides, monoglyceride derivatives, sucrose fatty acid esters, sorbitan fatty acid esters, glycerin fatty acid esters, propylene glycol fatty acid esters, calcium stearoyl lactate, and vegetable lecithin, and one or more of these may be used either individually or in combination.

1.5. Viscosity

The viscosity of the acidic oil-in-water type emulsified seasoning according to this embodiment is preferably 10,000 to 400,000 mPa·s, more preferably 15,000 to 400,000 mPa·s. When the viscosity is within the above-mentioned range, moderate viscosity is provided, and the constitutional deformation of the acidic oil-in-water type emulsified seasoning can be diminished in the range of 0.1 to 1% of oscillating strain representing the stage in which the acidic oil-in-water type emulsified seasoning according to this embodiment has just put into the rictus (stage 1). The viscosity of an acidic oil-in-water type emulsified seasoning used in the invention refers to a value obtained from readings at the time a rotor turns around two cycles after the measurement starts, by using a BH viscometer under the condition that the initial temperature is 20° C. and the rotation frequency is 2 rpm, and rotor No. 2 is used when the viscosity is less than 15,000 mPa·s, rotor No. 3 is used when the viscosity is in the range of 15,000 mPa·s or more to less than 37,500 mPa·s, rotor No. 4 is used when the viscosity is in the range of 37,500 mPa·s or more to less than 75,000 mPa·s, rotor No. 5 is used when the viscosity is in the range of 75,000 mPa·s or more to less than 150,000 mPa·s, rotor No. 6 is used when the viscosity is in the range of 150,000 mPa·s or more to less than 375,000 mPa·s, and rotor No. 7 is used when the viscosity is 375,000 mPa·s or more.

1.6. Oil Droplets and Water-Containing Solid Particles

The acidic oil-in-water type emulsified seasoning according to this embodiment may contain two types of particles (oil droplets and water-containing solid particles). As used herein, the average particle diameter of the water containing solid particle (solid particles being in water-absorbing condition) is larger than the average particle diameter of the oil droplets, and the ratio of average particle diameter 2 of the water-containing solid particle to average particle diameter 1 of the oil droplets (average particle diameter 2/average particle diameter 1) is 5 to 50 (preferably 5 to 40).

Thus, since the acidic oil-in-water type emulsified seasoning according to this embodiment contains two types of the particles (the oil droplets and the water-containing solid particles), the average particle diameter of the water-containing solid particles is larger than the average particle diameter of the oil droplets, and the ratio of average particle diameter 2 of the water-containing solid particle to average particle diameter 1 of the oil droplets (average particle diameter 2/average particle diameter 1) is 5 to 50, the oil droplets can be packed tightly between the water-containing solid particles, and therefore, these particles can exist in a high density in the acidic oil-in-water type emulsified seasoning while these particles contacts each other. Therefore, the acidic oil-in-water type emulsified seasoning with a sense of volume and good melt-in-the-mouth, in spite of having a low content of oils and fats (the content of oils and fats of 10 to 40 volume %), can be easily obtained.

### 1.6.1. First Example

### Particle Size Distribution

The first example of the acidic oil-in-water type emulsified seasoning according to this embodiment may comprise a first peak being present in the range of 0.5 to 5 micrometers and a second peak being present in the range of 20 to 80 micrometers. As used herein, the position of the “peak” refers to a vertex of a “mountain” being present in the particle size distribution. In this instance, when the acidic oil-in-water type emulsified seasoning according to this embodiment contains the cross-linked starch, the water-containing solid particles may be the cross-linked starch. In this instance, since the oil droplets (emulsion particles) are present between the cross-linked starch particles in the acidic oil-in-water type emulsified seasoning according to this embodiment, the oil droplets and the cross-linked starch particles are present in a high density in the acidic oil-in-water type emulsified seasoning according to this embodiment while the oil droplets and the cross-linked starch particles contact each other, and therefore, the acidic oil-in-water type emulsified seasoning with a sense of volume and good melt-in-the-mouth, in spite of having a low content of oils and fats content (content of oils and fats of 10 to 40 volume %), can be easily obtained. Furthermore, the size of the oil droplets can be adjusted by setting clearance condition, pressure, or the like in the emulsification apparatus used in accordance with common methods. Also, in this instance, the cross-linked starch which is the water-containing solid particle may be present as a swelling particle in the acidic oil-in-water type emulsified seasoning.

### 1.6.2. Second Example

The second example of the acidic oil-in-water type emulsified seasoning according to this embodiment may comprise the oil droplets and the water-containing solid particles, which have the above-mentioned ratio of the average particle diameters, and the water-containing solid particles may be the hotwater-soluble polysaccharide thickener (more specifically, the hotwater-soluble gum substance). In this instance, the ratio of the average particle diameter of the oil droplets to the average particle diameter of the hotwater-soluble polysaccharide thickener can be calculated by the average particle diameter of the oil droplets and the average particle diameter of the hotwater-soluble polysaccharide thickener, which are measured by the method described later. Also, in this instance, the hotwater-soluble polysaccharide thickener, which is the water-containing particle, is a swelling particle in the acidic oil-in-water type emulsified seasoning according to this embodiment.

As used herein, the average particle diameter of the oil droplets can be measured by using a laser diffraction particle size analyzer, MT3300EXII (manufactured by Nikkiso, Ltd.). Also, the average particle diameter of the hotwater-soluble polysaccharide thickener in the acidic oil-in-water type emulsified seasoning according to this embodiment can be measured by the above-mentioned method in column 1.3.

### 1.6.3. Water-Containing Solid Particles

Also, the acidic oil-in-water type emulsified seasoning according to this embodiment may comprise water-containing solid particles. That is, the water-containing solid particles are present as solid in a swollen state in the acidic oil-in-water type emulsified seasoning.

For example, the acidic oil-in-water type emulsified seasoning according to this embodiment preferably comprises the oil droplets and the water-containing solid particles and the average particle diameter of the water-containing solid particle is preferably larger than the average particle diameter of the oil droplets. In this instance, examples of the water-containing solid particles include for example, the above-mentioned cross-linked starch, the hotwater-soluble gum substances, and protein particles.

Furthermore, in the acidic oil-in-water type emulsified seasoning according to this embodiment, the proportion of the water-containing solid particles per unit volume of the aqueous phase is preferably 5 to 50%, more preferably 7 to 45%.

Since the proportion of the water-containing solid particles per unit volume of the aqueous phase is 5 to 50% in the acidic oil-in-water type emulsified seasoning according to this embodiment, the acidic oil-in-water type emulsified seasoning may have a sense of volume and good melt-in-the-mouth, in spite of having a low content of oils and fats content (content of oils and fats of 10 to 40 volume %).

Particles per unit volume may consist of one or plural types of particles. For example, in the acidic oil-in-water type emulsified seasoning according to this embodiment, the proportion (%) of the water-containing solid particles per unit volume of the aqueous phase is a value measured as follows.

Procedure 1: Measurement of Ratio X (volume %) of Volume of Water-containing Solid Particles in Acidic Oil-in-water Type Emulsified Seasoning.

A square bore of 1 cm on a side is hollowed in a sheet of chartula (average thickness of 20 micrometers), this chartula having the square bore is placed on the center of a glass slide. A small amount of an acidic oil-in-water type emulsified seasoning (about 0.05 g) is collected and placed on the chartula placed on the center of the glass slide (at a portion of the bore in the chartula), and then a cover glass is placed thereon and pushed slowly, and the cover glass which is closely-attached to the chartula is used as an observation sample. An enlarged image of this observation sample is shot by a digital microscope (magnification: 100 times) and observed. Furthermore, the observation sample is collected randomly at several portions from the acidic oil-in-water type emulsified seasoning as a sample, and an observation sample is formed for the each collected portion.

Mesh having bores of 10 micrometers on a side is placed on the shot image to measure the area of the water-containing solid particles in the area of 65 scales×40 scales. The area is measured by counting the number of the scales. Furthermore, 1 piece is counted when the solid particles saturates all of one mesh having the area of 10 micrometers×10 micrometers, and 0.5 piece is counted when the solid particles do not saturate all of one mesh. As the water-containing solid particles are pressed flat, the ratio {X (volume %)} of the water-containing solid particles in the acidic oil-in-water type emulsified seasoning can be calculated by calculating area×20 micrometers.

Procedure 2: Measurement of Ratio Y₂ of Volume of Aqueous Phase in Acidic oil-in-water Type Emulsified Seasoning

Ratio Y₁ (volume %) of the oil phase in the acidic oil-in-water type emulsified seasoning is obtained from the following formula based on specific gravity a of the oils and fats (for example, 0.9) and additive amount b (mass %) of the oil phase in the acidic oil-in-water type emulsified seasoning.

Y₁=[b/a]×100(volume %)

Ratio Y₂ (volume %) of the aqueous phase in the acidic oil-in-water type emulsified seasoning is obtained from the following formula based on specific gravity c (for example, 1.0) of the acidic oil-in-water type emulsified seasoning and the mass 100(%) of the acidic oil-in-water type emulsified seasoning.

Y₂=[100/C]−Y₁(volume %)

Procedure 3: Proportion of Water-containing Solid Particles in Aqueous Phase per Unit Volume

Subsequently, the proportion of the water-containing solid particles in the aqueous phase per unit volume in the acidic oil-in-water type emulsified seasoning=X/Y₂ (volume %) can be obtained from the ratio X (volume %) of the volume of the water-containing solid particles in the acidic oil-in-water type emulsified seasoning, which is obtained in procedure 1, and the ratio of Y₂ (volume %) of the volume of the aqueous phase in the acidic oil-in-water type emulsified seasoning, which is obtained in procedure 2. As used herein, the water-containing solid particles are present in the aqueous phase in the acidic oil-in-water type emulsified seasoning.

Thus, in the acidic oil-in-water type emulsified seasoning according to this embodiment, the proportion of the aqueous phase unit volume in the water-containing solid particles is 5 to 50% (preferably 7% to 45%), the particles can be present while contacting each other in the acidic oil-in-water type emulsified seasoning. Therefore, the acidic oil-in-water type emulsified seasoning has a sense of volume and good melt-in-mouth, in spite of having a low content of oils and fats (the content of oils and fats of 10 to 40 volume %).

1.7. Effect

For example, JP-B-7-112414 discloses a content ratio of starch in an acidic oil-in-water type emulsified food is generally 2 mass % to 4 mass %. Also, JP-A-7-59537 discloses a heat-resistant, freeze-resistance, mayonnaise-flavored pasty composition containing gelatinized starch and/or gum substances in the range of 1 mass % or more to 6 mass % or less.

However, when the acidic oil-in-water type emulsified food containing 0.5 mass % or more of the starch is manufactured in accordance with the description of JP-B-7-112414 and then is eaten, the obtained acidic oil-in-water type emulsified food has gooey and heavy texture at eating, on the other hand, when the pasty composition is manufactured in accordance with the description of JP-A-7-59537, the pasty composition may have terrible texture due to strongly gooey taste which is specific to gum substances. The texture differs from texture of general mayonnaise having the content of oils and fats in the range of about 65 mass % or more to 80 mass % or less of the total mass.

On the other hand, as described above, as the acidic oil-in-water type emulsified seasoning according to this embodiment has a sense of volume and good melt-in-mouth, which are similar to general mayonnaise having the content of oils and fats in the range of about 65 mass % or more to 80 mass % or less of the total mass and being in a state such that the oil droplets which are emulsion particles are in a tight packing condition.

### 2. Method for Manufacturing Acidic Oil-in-water Type Emulsified Seasoning

A method for manufacturing an acidic oil-in-water type emulsified seasoning according to this embodiment may contain mixing an aqueous phase which comprises egg yolk and preferably has the viscosity of 100 to 400,000 mPa·s, and an oil phase which preferably has the viscosity of 10 to 200 mPa·s. In this instance, the aqueous phase and the oil phase contain the components described in the above-mentioned column “1.4. Other Components”, respectively, and the each viscosity of the aqueous phase and the oil phase is a value measured before emulsification. Also, in this instance, the aqueous phase preferably contains the water-containing solid particles such as the cross-linked starch and the hotwater-soluble gum substance described above, having the similar properties to the oil droplets. Since the aqueous phase contains the water-containing solid particles such as the cross-linked starch and the hotwater-soluble gum substances, the oil droplets which are emulsion particles contact the water-containing solid particles to form a tight packing condition, accordingly, the condition can contribute to the formation of the acidic oil-in-water type emulsified seasoning with a moderate sense of volume. In particular, when the viscosity of the aqueous phase in the water-containing solid particles is adjusted at 100 to 400,000 mPa·s, preferably 200 to 300,000 mPa·s, the water-containing solid particles are dispersed homogenously in the aqueous phase, and the condition such that the oil droplets which are emulsion particles contact the water-containing solid particles can be easily maintained, and as a result, the acidic oil-in-water type emulsified seasoning with a sense of volume and good melt-in-mouth can be obtained.

### 3. Examples

The invention is further described below by way of examples. Note that the invention is not limited to the following examples. Each specific gravity of an acidic oil-in-water type emulsified seasoning and oil droplets, used in the examples, refers to values obtained by putting each of certain volume of the acidic oil-in-water type emulsified seasoning and the oil droplets in a cup and weighing respectively and dividing the obtained weight by the obtained volume.

### 3.1. Example 1

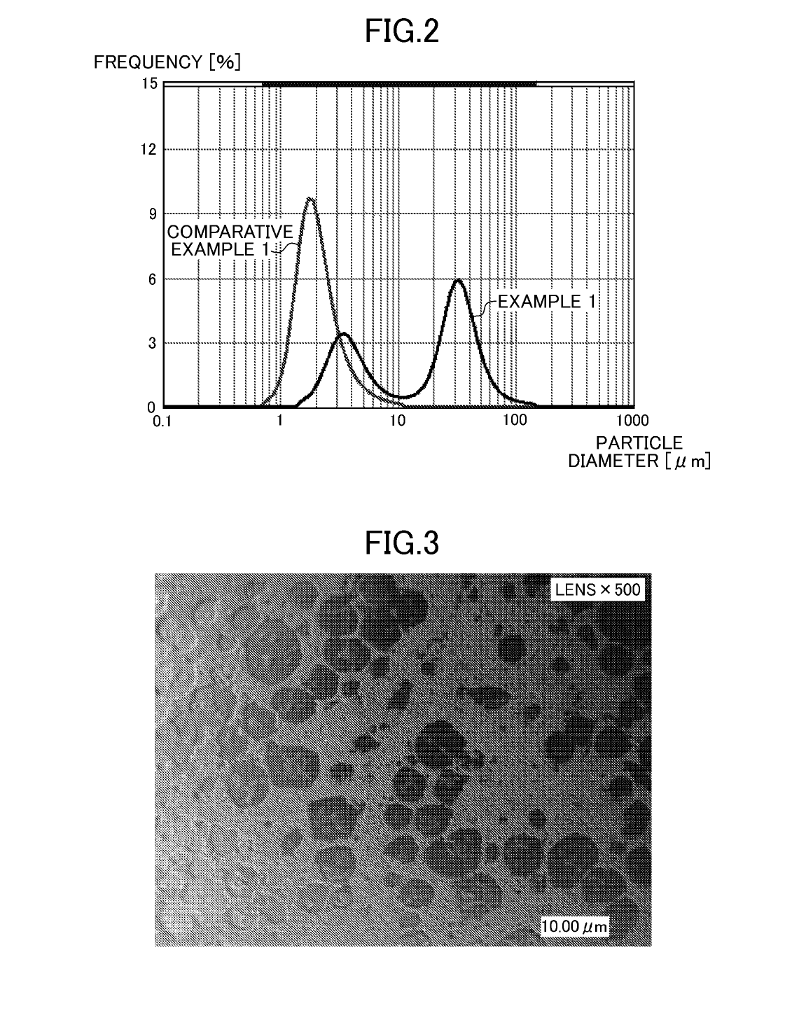

10 kg of vinegars, 43 kg of pure water, 2 kg of salt, and 5 kg of cross-linked starch made from waxy corn starch as a raw material (commercially available under the trade name “Farinex VA70WM”, manufactured by Matsutani Chemical Industry, Co., Ltd.) were mixed with a mixer to homogenize, and then heated up to 95° C. The mixture was cooled to 20° C., and then 10 kg of egg yolk containing 10 mass % of salt was mixed to manufacture aqueous phase (viscosity: 210 mPa·s), and next oil phase consisting of 30 kg of salad oil (viscosity: 30 mPa·s) was added and then preliminary emulsification was performed. The obtained preliminary-emulsified product was emulsified with a colloid mill to manufacture semi-solid salad dressing (an acidic oil-in-water type emulsified seasoning) of Example 1. The viscosity of the semi-solid salad dressing of Example 1 is 22, 500 mPa·s (measured by BH viscometer, manufactured by Toki Sangyo Co., Ltd.). Also, the particle size distribution of the semi-solid salad dressing of Example 1 was measured by using a laser diffraction particle size analyzer, and the particle size distribution having a first peak at the particle size of 3.6 micrometers and a second peak at the particle size of 30 micrometers, was obtained (see the particle size distribution of Example 1 in FIG. 2). In addition, A value (volume average particle diameter) was 39.3 micrometers, B value (volume average particle diameter) was 29.8 micrometers, shear resistance (A/B) was 0.8, and in this instance, the A value and the B value were measured for the cross-linked starch used in Example 1 in accordance with column “1.2. Cross-linked Starch”.

Also, the viscosity of the after-mentioned resulting mixture (water dispersion liquid containing 8 mass % of the cross-linked starch) was 13,000 mPa·s and the average particle diameter of the cross-linked starch being present in the resulting mixture was 29.8 micrometers. Note that the resulting mixture was obtained by the following process: a mixture of the cross-linked starch and water which contains 8 mass % of the cross-linked starch used in Example 1 was prepared, and was heated up to 90° C., and then was maintained at 90 for 5 minutes, and then was cooled to 20° C., and then was stirred at 10,000 rpm for 5 minutes using TK homomixer MARKII2.5type (manufactured by PRIMIX Corporation) to obtain the resulting mixture. Furthermore, average particle diameters of oil droplets, average particle diameters of cross-linked starch, and particle size distribution of semi-solid salad dressings in Example 1 and other examples and comparative examples to be hereinafter described, were measured by using a particle size analyzer, MT3300EXII (manufactured by Nikkiso, Ltd.). FIG. 3 shows an optical photomicrograph of the semi-solid salad dressing of Example 1. FIG. 3 demonstrates the cross-linked starch particles were present in the semi-solid salad dressing of Example 1. Additionally, the above-mentioned particle size distribution of Example 1 demonstrates the oil droplets and the cross-linked starch particles coexist in the semi-solid salad dressing of Example 1. In addition, the ratio of average particle diameter 2 of the cross-linked starch to average particle diameter 1 of oil droplets (average particle diameter 2/average particle diameter 1) in the semi-solid salad dressing of Example 1 was 8/1. Further, the proportion of the water-containing solid particles per unit volume of aqueous phase in the semi-solid salad dressing of Example 1, which was calculated in accordance with procedures 1 to 3 described above, was 54%.

### 3.2. Example 2

A semi-solid salad dressing (acidic oil-in-water type emulsified seasoning) of Example 2 was manufactured in accordance with the same procedure as described in Example 1, except the content of oils and fats was 40 kg, the content of the cross-linked starch was 4.5 kg (corresponding to 3.3 mass % in aqueous phase), and the content of the pure water was 33.5 kg. The viscosity of the semi-solid salad dressing of Example 2 was 265,000 mPa·s, and the viscosity of aqueous phase before emulsification was 100,000 mPa·s. Also, a particle size distribution having a first peak at the particle diameter of 2.3 micrometers and a second peak at the particle diameter of 31 micrometers was obtained by measuring the particle size distribution of the semi-solid salad dressing of Example 2 with the laser diffraction particle size analyzer. In addition, the ratio of average particle diameter 2 of the cross-linked starch to average particle diameter 1 of the oil droplets (average particle diameter 2/average particle diameter 1) was 13/1 in the semi-solid salad dressing of Example 2.

### 3.3. Example 3

A semi-solid salad dressing (acidic oil-in-water type emulsified seasoning) of Example 3 was manufactured in accordance with the same procedure as described in Example 1, except cross-linked starch (trade name “Foodstarch HR-7”, manufactured by Matsutani

Chemical Industry, Co., Ltd.) made from tapioca starch as a raw material, was added in place of the cross-linked starch (trade name “Farinex VA70WM”) used in Example 1, the additive amount of cross-linked starch was 6 kg (corresponding to 8.6 mass % in aqueous phase), and the content of the pure water was 42 kg. The viscosity of the semi-solid salad dressing of Example 3 was 110,000 mPa·s, and the viscosity of aqueous phase before emulsification was 100,000 mPa·s. Also, a particle size distribution having a first peak at the particle diameter of 2.0 micrometers and a second peak at the particle diameter of 78 micrometers was obtained by measuring the particle size distribution of the semi-solid salad dressing of Example 3 with the laser diffraction particle size analyzer. In addition, the ratio of average particle diameter 2 of the cross-linked starch to average particle diameter 1 of the oil droplets (average particle diameter 2/average particle diameter 1) was 39/1 in the semi-solid salad dressing of Example 3. Additionally, the proportion of the water-containing solid particles per unit volume of aqueous phase in the semi-solid salad dressing of Example 3, which was calculated in accordance with procedures 1 to 3 described above, was 60%. Furthermore, A value (volume average particle diameter) was 29.3 micrometers, B value (volume average particle diameter) was 27.1 micrometers, shear resistance (A/B) was 0.9, and in this instance, the A value and the B value were measured for the cross-linked starch used in Example 3 in accordance with column “1.2. Cross-linked Starch”.

Also, the viscosity of the after-mentioned resulting mixture (water dispersion liquid containing 8 mass % of cross-linked starch) was 150 mPa·s and the average particle diameter of the cross-linked starch being present in the resulting mixture was 27.1 micrometers. Note that the resulting mixture was obtained by the following process: a mixture of the cross-linked starch and water which contains 8 mass % of the cross-linked starch used in Example 3 was prepared, and was heated up to 90° C., and then was maintained at 90° C. for 5 minutes, and then was cooled to 20° C., and then was stirred at 10,000 rpm for 5 minutes using TK homomixer to obtain the resulting mixture.

### 3.4. Comparative Example 1

A semi-solid salad dressing (acidic oil-in-water type emulsified seasoning) of Comparative Example 1 was manufactured in accordance with the same procedure as described in Example 1, except gelatinized starch made from waxy corn starch as a raw material was added in place of the cross-linked starch in the method for manufacturing the semi-solid salad dressing of Example 1. The viscosity of the semi-solid salad dressing of Comparative Example 1 was 94,000 mPa·s. Also, a particle size distribution of the semi-solid salad dressing of Comparative Example 1, measured by using the laser diffraction particle size analyzer, shows only a first peak at the particle diameter of 1.9 micrometers (see the left particle size distribution in FIG. 2).

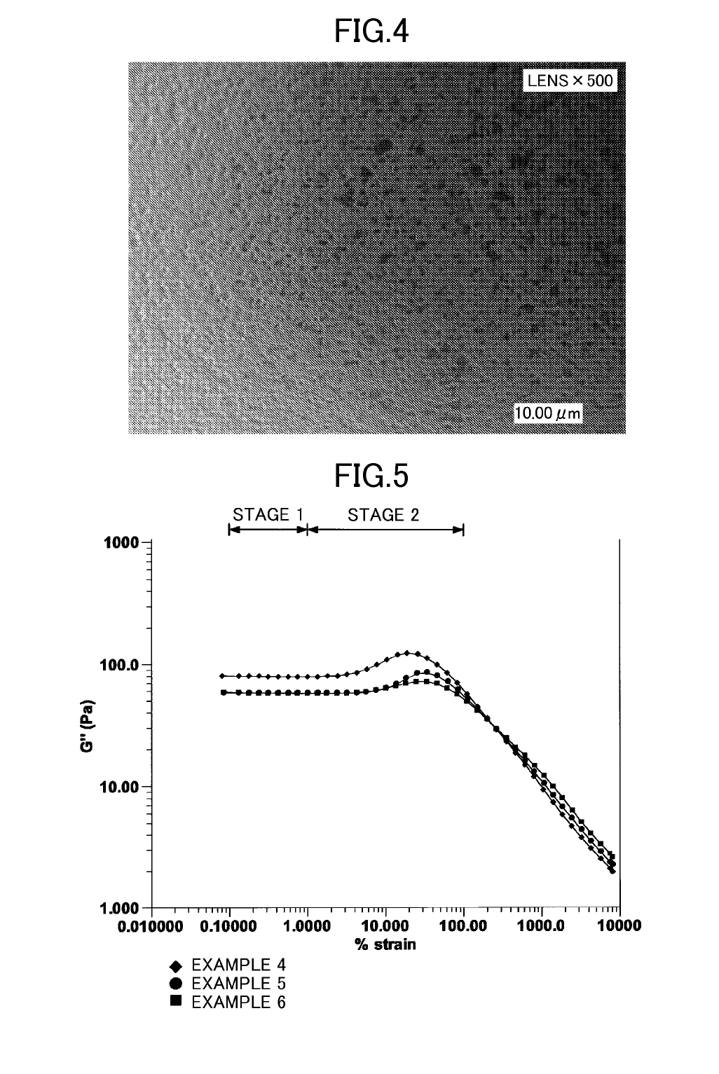

Furthermore, the viscosity of the after-mentioned resulting mixture (water dispersion liquid containing 8 mass % of the gelatinized starch) was 44,000 mPa·s. Note that the resulting mixture was obtained by the following process: a mixture of the gelatinized starch and water which contains 8 mass % of the cross-linked starch used in Comparative Example 1 was prepared, and was heated up to 90° C., and then was maintained at 90° C. for 5 minutes, and then was cooled to 20° C., and then was stirred at 10,000 rpm for 5 minutes using TK homomixer to obtain the resulting mixture. FIG. 4 is an optical photomicrograph of the semi-solid salad dressing of Comparative Example 1. According to FIG. 4, the gelatinized starch was not detected in the semi-solid salad dressing of Comparative Example 1. Moreover, it is understandable that the semi-solid salad dressing of Comparative Example 1 consists of only oil droplets (emulsion particles), judging from the particle size distribution of the above-mentioned semi-solid salad dressing of Comparative Example 1.

### 3.5. Comparative Example 2

Mayonnaise (acidic oil-in-water type emulsified seasoning) of Comparative Example 2 was manufactured in accordance with the same procedure as described in Example 3, except cross-linked starch (trade name “National 104”, manufactured by National Starch) made from tapioca starch as a raw material, was added in place of the cross-linked starch of the trade name “Foodstarch HR-7” in the method for manufacturing the semi-solid salad dressing of Example 3. The viscosity of the mayonnaise of Comparative Example 2 was 100,000 mPa·s. Furthermore, A value (volume average particle diameter) was 28.1 micrometers, B value (volume average particle diameter) was 28.4 micrometers, shear resistance (A/B) was 1, and in this instance, the A value and the B value were measured for the cross-linked starch used in Comparative Example 2 in accordance with column “1.2. Cross-linked Starch”.

Furthermore, the viscosity of the after-mentioned resulting mixture (water dispersion liquid containing 8 mass % of the cross-linked starch) was 100 mPa·s, and the average particle diameter and the average particle diameter of the cross-linked starch being present in the resulting mixture was 28.4 micrometers. Note that the resulting mixture was obtained by the following process: a mixture of the cross-linked starch and water which contains 8 mass % of the cross-linked starch used in Comparative Example 2 was prepared, and was heated up to 90° C., and then was maintained at 90° C. for 5 minutes, and then was cooled to 20° C., and then was stirred at 10,000 rpm for 5 minutes using TK homomixer to obtain the resulting mixture.

### 3.6. Test Example 1

Each dynamic viscoelasticity of the semi-solid salad dressings manufactured in Examples 1 to 3 and Comparative Examples 1 and 2 was measured by the following method.

Measuring apparatus: Rheometer AR-G2, manufactured by TA Instruments
Geometry: parallel plate, phi 40 mm, made of aluminum
Gap: 1400 micrometers
Measurement mode: Strain dispersal measurement (Strain sweep step) Oscillating strain sweep measurement
Default temperature setting: 25.0° C.
Measurement temperature: 35.0° C. (Measurement is performed after equilibrating for 30 minutes after reaching to the measurement temperature)
Amplitude frequency: 6.283 rad/s (1 Hz)
Oscillating strain: 0.1 to 8000%
Measurement interval: 8 points/tenfold strain interval

Also, sensory assessment for the semi-solid salad dressings manufactured in Examples 1 to 3 and Comparative Examples 1 and 2 was performed by the following method.

Evaluation of texture in comparison with mayonnaise having the oil content of 70 mass % was performed by specialized panelists. The evaluation was demonstrated on the basis that “Excellent” in the case of having very similar texture to the texture of the mayonnaise having the oil content of 70 mass % with a sense of volume and good melt-in-the-mouth, “Good” in the case of having similar texture of the mayonnaise having the oil content of 70 mass %, and “So-so” in the case of not having similar texture of the mayonnaise having the oil content of 70 mass %.

Furthermore, the above-mentioned mayonnaise having the oil content of 70 mass % was manufactured similarly as described in Example 1, except the cross-linked starch was not added, the additive amount of the salad oil was 70 kg, and the content of the pure water was 8 kg in the composition of Example 1.

Table 1 shows the result of the above-described test.

TABLE 1

| | | | | Comparative | Comparative |
|---|---|---|---|---|---|
| | Example 1 | Example 2 | Example 3 | Example 1 | Example 2 |
| Maximum value (G″ₛ) of | 11.62 | 140.60 | 160.95 | 127.00 | 119.00 |
| Loss Elastic Modulus in | | | | | |
| the range of 0.1 to 1% | | | | | |
| of Oscillating Strain | | | | | |
| Oscillating Strain at | 0.15 | 0.07 | 0.11 | 0.07 | 0.07 |
| G″s | | | | | |
| Maximum value (G″_{d}) of | 19.12 | 313.05 | 250.70 | 150.00 | 120.70 |
| Loss Elastic Modulus in | | | | | |
| the range of 1 to 100% | | | | | |
| of Oscillating Strain | | | | | |
| Oscillating Strain at | 18.79 | 25.58 | 13.96 | 25.14 | 5.74 |
| G″_{d} | | | | | |
| G″_{d}/G″ₛ | 1.65 | 2.20 | 1.56 | 1.18 | 1.01 |
| Presence or Absence of | Presence | Presence | Presence | Absence | Absence |
| a peak in the range of | | | | | |
| 1 to 100% of Oscillating | | | | | |
| Strain | | | | | |
| Sensory Assessment | Excellent | Excellent | Good | So-so | So-so |

As shown in Table 1 and FIG. 1, in the acidic oil-in-water type emulsified seasonings of Examples 1 to 3, since the content of oils and fats is 10 to 40 mass %, and the oscillating strain and the loss elastic modulus (G″), which are indicative of dynamic viscoelasticity measured by the following condition with a rheometer, have the following relationship, the acidic oil-in-water type emulsified seasonings of Examples 1 to 3 have a sense of volume and good melt-in-the-mouth, in spite of having a low content of oils and fats and being low-calorie.

Condition: At a temperature of 25 to 35° C. and at an angular frequency of 6.2 rad/s

Relationship: A peak of the loss elastic modulus (G″) is present in the range of 1 to 100% of the oscillating strain, and the loss elastic modulus at the peak (G″_{d}) is larger than the maximum value of the loss elastic modulus (G″ₛ) in the range of 0.1 to 1% of the oscillating strain.

### 3.7. Example 4

10 kg of vinegars, 45.6 kg of pure water, 2 kg of salt, 2 kg of hotwater-soluble carrageenan as a hotwater-soluble gum substance, and 0.4 kg of xanthane gum were mixed to homogenize, and then 10 kg of egg yolk containing 10 mass % of salt was mixed to manufacture aqueous phase (viscosity 200,000 mPa·s), and then oil phase consisting of 30 kg of salad oil was added and preliminary emulsification was performed. The obtained preliminary-emulsified product was emulsified with a colloid mill to manufacture semi-solid salad dressing (an acidic oil-in-water type emulsified seasoning) of Example 4.

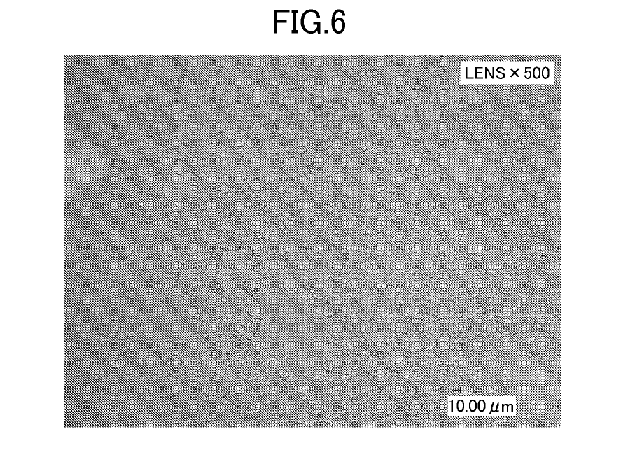

The viscosity of the semi-solid salad dressing of Example 4 is 70,000 mPa·s (measured by BH viscometer, manufactured by Toki Sangyo Co., Ltd.), and the viscosity of the aqueous phase before emulsification was 60,000 mPa·s. The semi-solid salad dressing of Example 4 was observed by a microscope (Digital Microscope, manufactured by Keyence Corporation) to measure the average particle diameter, and the average particle diameter of the oil droplets was 5.1 micrometers, and the average particle diameter of the hotwater-soluble carrageenan was 65 micrometers. FIG. 6 is an optical photomicrograph of the semi-solid salad dressing of Example 4. FIG. 6 demonstrates the hotwater-soluble carrageenan is present in particle state together with the oil droplets in the aqueous phase of the semi-solid salad dressing of Example 4. The ratio of average particle diameter 2 of the hotwater-soluble carrageenan to average particle diameter 1 of oil droplets (average particle diameter 2/average particle diameter 1) in the semi-solid salad dressing of Example 4 was 13/1. Also, the proportion of the water-containing solid particles per unit volume of aqueous phase in the semi-solid salad dressing of Example 4, which was calculated in accordance with procedures 1 to 3 described above, was 7%.

### 3.8. Example 5

A semi-solid salad dressing (acidic oil-in-water type emulsified seasoning) of Example 5 was manufactured in accordance with the same procedure as described in Example 4, except hotwater-soluble gum arabic was added as a hotwater-soluble gum substance in place of carrageenan, the additive amount of xanthane gum was 0.8 kg, and the additive amount of the pure water was 45.2 kg.

The viscosity of the semi-solid salad dressing of Example 5 is 105,000 mPa·s (measured by BH viscometer, manufactured by Toki Sangyo Co., Ltd.), and the viscosity of aqueous phase before emulsification was 80,000 mPa·s.

### 3.9. Example 6

A semi-solid salad dressing (acidic oil-in-water type emulsified seasoning) of Example 6 was manufactured in accordance with the same procedure as described in Example 4, except hotwater-soluble tamarind gum was added as a hotwater-soluble gum substance in place of carrageenan, the additive amount of xanthane gum was 0.5 kg, and the additive amount of the pure water was 45.5 kg.

The viscosity of the semi-solid salad dressing of Example 6 is 75,000 mPa·s (measured by BH viscometer, manufactured by Toki Sangyo Co., Ltd.), and the viscosity of aqueous phase before emulsification was 40,000 mPa·s. The semi-solid salad dressing of Example 6 was observed by a microscope (Digital Microscope, manufactured by Keyence Corporation) to measure the average particle diameter and the average particle diameter of the oil droplets was 5.7 micrometers, and the average particle diameter of the hotwater-soluble tamarind gum was 84 micrometers. Also, the ratio of average particle diameter 2 of the hotwater-soluble tamarind gum to average particle diameter 1 of oil droplets (average particle diameter 2/average particle diameter 1) in the semi-solid salad dressing of Example 6 was 15/1. Additionally, the proportion of the water-containing solid particles per unit volume of aqueous phase in the semi-solid salad dressing of Example 6, which was calculated in accordance with procedures 1 to 3 described above, was 5%.

Measurements of each dynamic viscoelasticity and sensory assessment for the semi-solid salad dressings manufactured in Examples 4 to 6 were performed by the method described in the above-mentioned Test Example 1. Table 2 shows the results.

TABLE 2

| | Example 4 | Example 5 | Example 6 |
|---|---|---|---|
| | hotwater-soluble | hotwater-soluble | hotwater-soluble |
| | carrageenan | gum arabic | tamarind gum |
| Maximum | 80.7 | 58.26 | 59.11 |
| value (G″ₛ) | | | |
| of Loss | | | |
| Elastic | | | |
| Modulus in | | | |
| the range of | | | |
| 0.1 to 1% of | | | |
| Oscillating | | | |
| Strain | | | |
| Oscillating | 0.07 | 0.13 | 0.07 |
| Strain at | | | |
| G″ₛ | | | |
| Maximum | 124.9 | 85.45 | 72.48 |
| value (G″_{d}) | | | |
| of Loss | | | |
| Elastic | | | |
| Modulus in | | | |
| the range of | | | |
| 1 to 100% of | | | |
| Oscillating | | | |
| Strain | | | |
| Oscillating | 18.79 | 34.71 | 34.71 |
| Strain at | | | |
| G″_{d} | | | |
| G″_{d}/G″ₛ | 1.55 | 1.47 | 1.23 |
| Presence or | Presence | Presence | Presence |
| Absence of a | | | |
| peak in the | | | |
| range of 1 to | | | |
| 100% of | | | |
| Oscillating | | | |
| Strain | | | |
| Sensory | Excellent | Good | Good |
| Assessment | | | |

As shown in Table 2 and FIG. 6, in the acidic oil-in-water type emulsified seasonings of Examples 4 to 6, since the content of oils and fats is 10 to 40 mass %, and the oscillating strain and the loss elastic modulus (G″), which are indicative of dynamic viscoelasticity measured by the following condition with a rheometer, have the following relationship, the acidic oil-in-water type emulsified seasonings of Examples 1 to 3 have a sense of volume and good melt-in-the-mouth, in spite of having a low content of oils and fats and being low-calorie.

Condition: At a temperature of 25 to 35° C. and at an angular frequency of 6.2 rad/s

Relationship: A peak of the loss elastic modulus (G″) is present in the range of 1 to 100% of the oscillating strain, and the loss elastic modulus at the peak (G″_{d}) is larger than the maximum value of the loss elastic modulus (G″ₛ) in the range of 0.1 to 1% of the oscillating strain.

1. An acidic oil-in-water type emulsified seasoning comprising egg yolk,
wherein the content of oils and fats is 10 to 40 mass %, and
wherein the oscillating strain and the loss elastic modulus (G″), which are indicative of dynamic viscoelasticity measured by the following condition with a rheometer, have the following relationship.
Condition: At a temperature of 25 to 35° C. and at an angular frequency of 6.2 rad/s
Relationship: A peak of the loss elastic modulus (G″) is present in the range of 1 to 100% of the oscillating strain, and the loss elastic modulus at the peak (G″_{d}) is larger than the maximum value of the loss elastic modulus (G″ₛ) in the range of 0.1 to 1% of the oscillating strain.

2. The acidic oil-in-water type emulsified seasoning according to claim 1,
wherein G″_{d} and G″ₛ have the following relationship.
G″_{d}/G″ₛ≧1.5

3. The acidic oil-in-water type emulsified seasoning according to claim 1,
wherein the peak of the loss elastic modulus (G″) is present in the range of 10 to 40% of the oscillating strain.

4. The acidic oil-in-water type emulsified seasoning according to claim 1, further comprising a cross-linked starch,
wherein the cross-linked starch has the following characteristics:
the viscosity of a mixture of the cross-linked starch and water prepared under the following condition is 120 to 20,000 mPa·s; and
the average particle diameter of the cross-linked starch being present in the mixture is 20 to 40 micrometers.
Condition: A mixture of the cross-linked starch and water comprising 8 mass % of the cross-linked starch is heated up to 90° C., and then is maintained at 90° C. for 5 minutes, and then is cooled to 20° C., and then is stirred at 10,000 rpm for 5 minutes with a homomixer.

5. The acidic oil-in-water type emulsified seasoning according to claim 4,
wherein the cross-linked starch has a shear resistance of 0.7 to 0.9 calculated from the following procedures (1) to (3).
procedure (1): A mixture of the cross-linked starch and water comprising 8 mass of the cross-linked starch is heated up to 90° C., and then is maintained at 90° C. for 5 minutes, and then is cooled to 20° C., and then is stirred with a vertical mixer (to which a wire whip is attached) on scale 6 for 3 minutes to obtain a resulting mixture, and a volume average particle diameter A of the cross-linked starch in the resulting mixture is measured by laser diffraction particle size distribution analysis.
procedure (2): The mixture of the cross-linked starch and water comprising 8 mass % of the cross-linked starch obtained by procedure (1) is stirred at 10,000 rpm for 5 minutes with a homomixer to obtain a resulting mixture, and a volume average particle diameter B of the cross-linked starch in the resulting mixture is measured by laser diffraction particle size distribution analysis.
procedure (3): A shear resistance is calculated from the following calculating formula.
shear resistance=B/A

6. The acidic oil-in-water type emulsified seasoning according to claim 4,
wherein the content of the cross-linked starch in an aqueous phase of the acidic oil-in-water type emulsified seasoning is 2 to 10 mass %.

7. The acidic oil-in-water type emulsified seasoning according to claim 1, further comprising a hotwater-soluble polysaccharide thickener (except a starch) in an aqueous phase,
wherein the average particle diameter of the hotwater-soluble polysaccharide thickener being present in the aqueous phase is 15 to 200 micrometers.

8. The acidic oil-in-water type emulsified seasoning according to claim 1, further comprising water-containing solid particles and oil droplets,
wherein an average particle diameter of the water-containing solid particles is larger than an average particle diameter of the oil droplets, and
wherein in the case the average particle diameter of the oil droplet is defined as average particle diameter 1 and the average particle diameter of the water-containing solid particles is defined as average particle diameter 2, the ratio of the average particle diameter 2 to the average particle diameter 1 (the average particle diameter 2/the average particle diameter 1) is 5 to 50.

9. The acidic oil-in-water type emulsified seasoning according to claim 8,
wherein the proportion of the water-containing solid particles per unit volume of an aqueous phase is 5 to 50%.
